(19) United States
(12) Patent Application Publication
(10) Pub. No.: US 2024/0127028 A1
(43) Pub. Date: Apr. 18, 2024

(54) INFORMATION PROCESSING DEVICE, INFORMATION PROCESSING SYSTEM AND INFORMATION PROCESSING METHOD

(71) Applicant: Preferred Networks, Inc., Tokyo-to (JP)

(72) Inventor: Daisuke TANIWAKI, Tokyo-to (JP)

(73) Assignee: Preferred Networks, Inc., Tokyo-to (JP)

(21) Appl. No.: 18/533,491

(22) Filed: Dec. 8, 2023

Related U.S. Application Data
(63) Continuation of application No. PCT/JP2022/023519, filed on Jun. 10, 2022.
(60) Provisional application No. 63/209,419, filed on Jun. 11, 2021.

(51) Int. Cl. G06N 3/04

(52) U.S. Cl. CPC G06N 3/04

(57) ABSTRACT

An information processing device includes one or more memories and one or more processors. The one or more processors are configured to receive information on a plurality of graphs from one or more second information processing devices; select a plurality of graphs which are simultaneously processable using a graph neural network model among the plurality of graphs; input information on the plurality of graphs which are simultaneously processable into the graph neural network model and simultaneously process the information on the plurality of graphs which are simultaneously processable to acquire a processing result for each of the plurality of graphs which are simultaneously processable; and transmit the processing result to the second information processing device which has transmitted the corresponding information on the graph.

### CROSS REFERENCE TO THE RELATED APPLICATIONS

This application is continuation application of International Application No. JP2022/023519, filed on Jun. 10, 2022, which claims priority to the U.S. Provisional Patent Application No. 63/209,419, filed on Jun. 11, 2021, the entire contents of which are incorporated herein by reference.

### FIELD

This disclosure relates to an information processing device, an information processing system and an information processing method.

### BACKGROUND

Nowadays, there is a widely used system in which a client used by a user transmits contents desired to be subjected to an arithmetic operation to a server, the server executes the arithmetic operation, and the user receives an arithmetic operation result. For example, there is a system in which the user transmits data to a provider via the internet line and receives a processing result from the provider after appropriate processing.

In the case of executing an arithmetic operation with a large amount of data, a cluster of processors such as a GPU (Graphics Processing Unit) is often used as the server. In the case of using such a GPU core as the cluster, a plurality of arithmetic operations transmitted from a plurality of clients are, for example, change of the order or assignment of the server according to the priorities of tasks and queues. In the service using a model such as a neural network, the computation cost required for an individual task is high and the time required for the computation may be long, and therefore, it is required to effectively use resources of a computer according to the tasks transmitted from a plurality of clients.

### BRIEF DESCRIPTION OF DRAWINGS

FIG. 1 is a diagram schematically illustrating an information processing system according to an embodiment.

FIG. 2 is a chart for explaining processing of graphs at the same timing according to an embodiment.

FIG. 3 is a chart for explaining timing of processing of the graphs at the same timing according to an embodiment.

FIG. 4 is a diagram schematically illustrating an information processing system according to an embodiment.

FIG. 5 is a chart for explaining timing of processing of graphs at the same timing according to an embodiment.

FIG. 6 is a diagram schematically illustrating an information processing system according to an embodiment.

FIG. 7 is a diagram schematically illustrating an information processing system according to an embodiment.

FIG. 8 is a diagram illustrating an implementation example of components of an information processing system according to an embodiment.

### DETAILED DESCRIPTION

According to an embodiment, an information processing device includes one or more memories and one or more processors. The one or more processors are configured to receive information on a plurality of graphs from one or more second information processing devices; select a plurality of graphs which are simultaneously processable using a graph neural network model among the plurality of graphs; input information on the plurality of graphs which are simultaneously processable into the graph neural network model and simultaneously process the information on the plurality of graphs which are simultaneously processable to acquire a processing result for each of the plurality of graphs which are simultaneously processable; and transmit the processing result to the second information processing device which has transmitted the corresponding information on the graph.

Hereinafter, embodiments of the present invention will be explained with reference to the drawings. The drawings and the explanation of the embodiments are indicated as examples and are not intended to limit the present invention.

### First Embodiment

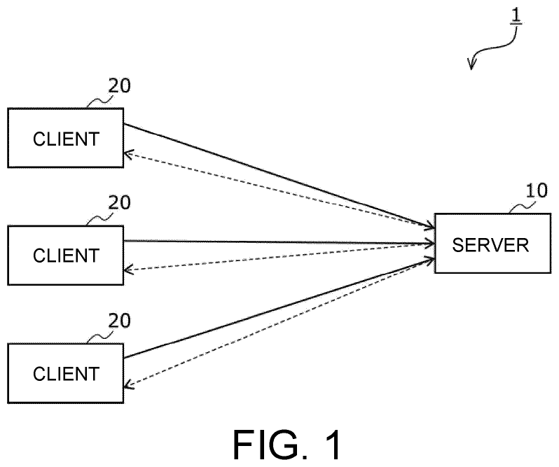

FIG. 1 is a diagram schematically illustrating a configuration of an information processing system according to an embodiment. An information processing system 1 is a system including a server 10 (an example of a first information processing device), and executes processing in the server 10 based on a request from a client 20 (an example of a second information processing device). The server 10 and the client 20 are connected via a wired or wireless line such as an internet line.

Further, the one having another configuration such as a load balancer explained in a later-explained embodiment is not excluded, and, for example, data is not directly transmitted from the client 20 to the server 10 but an intermediate server such as a proxy server may be provided in this embodiment.

Further, the data is not limited to the one directly transmitted from the client 20 to the server 10 but may be the one transmitted via another device. For example, such a configuration may be adopted that the client 20 stores the data in a file server or the like and notifies the server 10 of its storage destination so that the server 10 reads the data for the request from each client 20 from the file server or the like. This also applies to a result of an arithmetic operation performed by the server 10, and the server 10 may directly transmit it to the client 20 or may transmit it via another device. For example, the client 20 may acquire the arithmetic operation result, for example, via the file server or the like.

The server 10 is, as an example, an arithmetic server configured including an accelerator which processes the same processing using a plurality of arithmetic cores at the same timing. The accelerator has, for example, a GPU, and executes the processing based on the same arithmetic operation by the plurality of arithmetic cores at the same timing using a technique of GPGPU (General-Purpose computing on GPU).

In other words, the server 10 may have a configuration of SIMD (Single Instruction, Multiple Data) that one program is started in the host of the GPU and the same processing based on the same clock is executed on a plurality of pieces of data in the plurality of arithmetic cores according to this program. As a matter of course, the server 10 may have a configuration capable of realizing the SIMD arithmetic operation in a configuration other than the GPU.

As an embodiment, the server 10 receives (solid lines) different pieces of data from the plurality of clients 20, executes arithmetic operations by parallel processing, and transmits (dotted lines) arithmetic operation results to the respective clients 20.

In this embodiment, an example of executing processing in a trained model will be explained as the processing of the server 10. As a non-limited example, the server 10 uses a neural network model into which information on a graph can be input (for example, GNN: Graph Neural Network) as the trained model.

In the server 10, the processor deploys an NNP (Neural Network Potential) model being a neural network model trained to output information about energy when graph information on atoms is input, and processes a plurality of pieces of graph information about atoms in parallel using the NNP model, as an example. The graph information includes pieces of information on a plurality of atoms.

The information on the atom may include, for example, information about the type of atom constituting a substance and coordinates of the atom (position of the atom). A graph using the information on the atom as a node and the connection of atoms as an edge is formed, and the graph is input into the NNP model, whereby the server 10 infers physical property information (for example, energy, force, and so on) in a state of a substance (graph) to be transmitted from each of the clients 20, and transmits it to the client 20. Note that the server 10 may transmit information obtained by processing or analyzing the information output from the NNP model, to the client 20.

For example, the information on the graph indicating the atomic arrangement of the substance is input into in the NNP model. The server 10 inputs, into the trained model, the information on the graph received from a certain client 20 and the information on the graph received from a different client 20 while separating them from each other. The trained model executes an arithmetic operation for each piece of information on a graph in a manner not to influence the arithmetic operation of the other graph.

As an example, a case where the server 10 receives a 1st graph G1 having a first number of nodes n1 (=first atomicity) indicating a first substance having a first atomicity from a client 20A and receives a 2nd graph G2 having a second number of nodes n2 (=second atomicity) indicating a second substance having a second atomicity from a client 20B will be explained.

In the accelerator of the server 10, the number of nodes (predetermined number of nodes N) which can be processed at the same timing by its resources is set in advance as an example. The server 10 has an upper limit in data amount which can be processed all at once due to the resources, for example, a memory amount, a core amount, or another arithmetic capacity, representatively, the memory amount, and therefore the number of nodes which are collectively processed can be set. Besides, there is a possibility that the batch processing is impossible due to the memory capacity also due to the number of edges other than the number of nodes.

Note that hereinafter, the number of nodes is used for the explanation as an example, and can be read as any one of “the number of nodes”, “the number of edges”, “a number based on the number of nodes”, “a number based on the number of edges”, and “a number based on both the number of nodes and the number of edges”, or may be read as another amount in the graph arithmetic operation. For example, there is a portion where it is determined that the number of nodes n1 of the 1st graph G1+the number of nodes n2 of the 2nd graph G2<=the predetermined number of nodes N, and this can be read as the number of edges e1 of the 1st graph G1+the number of edges e2 of the 2nd graph G2<=the predetermined number of edges E, or may be read as a number x1 based on the number of nodes and the number of edges of the 1st graph G1+a number x2 based on the number of nodes and the number of edges of the 2nd graph G2<=a predetermined threshold value X based on the number of nodes and the number of edges.

N may be decided from the required arithmetic resources (for example, the memory amount, the core amount) estimated from the number of nodes. E may be decided from the required arithmetic resources estimated from the number of edges. X may be decided from the total sum of the number of nodes and the number of edges, the weighting addition of the number of nodes and the number of edges, or the required arithmetic resources estimated from the number of nodes and the number of edges.

In any case, instead of a simple sum using the number of nodes or the like, a sum may be found after use of an appropriate conversion. For example, it may be adopted that a function f(n1) using the number of nodes n1 of the 1st graph G1 as an argument+a function f(n2) using the number of nodes n2 of the 2nd graph G2 as an argument<=a predetermined threshold value F of resources about the number of nodes or the like, where f is, for example, a function for acquiring the resources required for the arithmetic operation of the graph in the number of nodes and is a linear or nonlinear function. As a matter of course, also in the case of using the number of edges and the case of using both the number of nodes and the number of edges, the same definition can be made.

In the case where the sum of the first number of nodes n1 and the second number of nodes n2 is equal to or less than the predetermined number of nodes N, the processing of the 1st graph G1 and the 2nd graph G2 is executed at the same timing, and analysis or inferring processing about the first substance and the second substance is executed.

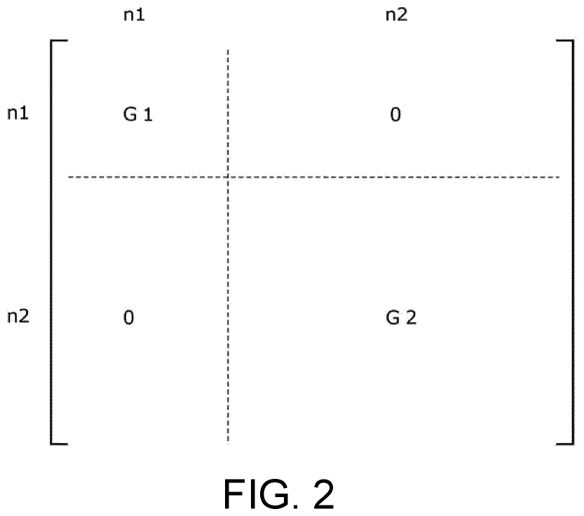

FIG. 2 is a chart for explaining an example of the processing of the graph in the server 10. The server 10 expands the information about the graph acquired from each of the clients 20, for example, into a matrix. Its expansion method just needs to be any method as long as it is a form capable of appropriately performing an arithmetic operation of the graph in the trained model.

The server 10 generates, for example, a sparse matrix (an example of input information into the model) made by coupling a matrix including an adjacency matrix of the 1st graph G1 and a matrix including an adjacency matrix of the 2nd graph G2 as illustrated in FIG. 2. Note that the server 10 does not actually generate the sparse matrix but may have a mode which generates it in a representation appropriately converted in consideration of the resources of the memory and the arithmetic time and can appropriately perform an arithmetic operation on the representation. For example, “0” in the sparse matrix may be appropriately deleted to converted it into a representation which describes the position of an element and the content of the element in association. In FIG. 2, it is assumed that n1+n2<=N.

The trained model to be used for the NNP, for example, performs an arithmetic operation on components having values other than 0 in a row and a column in the matrix to acquire a result. This model generates the matrix as in FIG. 2 and thereby can execute an arithmetic operation in a manner that the information on the 1st graph G1 acquired from the first client 20A and the information on the 2nd graph G2 acquired from the second client 20B do not influence each other.

Since the arithmetic operation can be executed on each of the graphs without influencing each other, for example, the server 10 or the client 20 finally adds the energy values of the nodes belonging to each of the graphs to acquire the energy of an individual graph.

For example, the server 10 assigns the arithmetic operation for each atom being the node of each graph to the arithmetic core and thereby can execute processing in synchronization on the information for each atom. In the trained model, the number of intermediate layers which perform the arithmetic operations does not generally change depending on the number of nodes. Therefore, assigning the arithmetic core to each node makes it possible to acquire the physical property information at the same timing irrespective of the numerical values of n1, n2.

Note that the assignment of the computation in the arithmetic core does not need to be made on a node basis, but the server 10 just needs to have a mode capable of assigning the arithmetic operations so that the batch processing can be appropriately executed. Therefore, it is not necessary to perform the arithmetic operations on all of the nodes at the same timing, but it is only necessary to be able to perform the arithmetic operations at the same timing in an appropriate processing unit. The batch processing can improve the throughput as a whole.

The above arithmetic operation unit may be appropriately decided, for example, by the server 10, or may be appropriately decided by the accelerator included in the server 10. Further, it may be decided by a user by describing a program, or may be decided in an execution file or an intermediate file by a compiler. Based on the deciding methods, the above predetermined number of nodes N may be defined.

As explained above, when the sum of the first number of nodes n1 and the second number of nodes n2 is equal to or less than the predetermined number of nodes N, the server 10 can input pieces of the information about the 1st graph and the 2nd graph into the trained model at the same timing and execute the arithmetic operations in a manner such that they do not interfere with each other. This processing makes it possible for the information processing system 1 to process pieces of the graph information received from separate clients 20 without wasting the resources and acquire pieces of the physical property information on the first substance and the second substance.

For example, the matrix in FIG. 2 may be configured including four matrices of the type of atom (one), the coordinates (three), and the adjacency matrix (one). Note that the above batch processing of the graph is one example, and another method may be used to collectively process a plurality of graphs. As one example, the following method may be used. https://www.slideshare.net/pfi/20190930-pfn-internship-2019-extension-of-chainerchennistry-for-large-amp-sparse-graphkenshin-abe

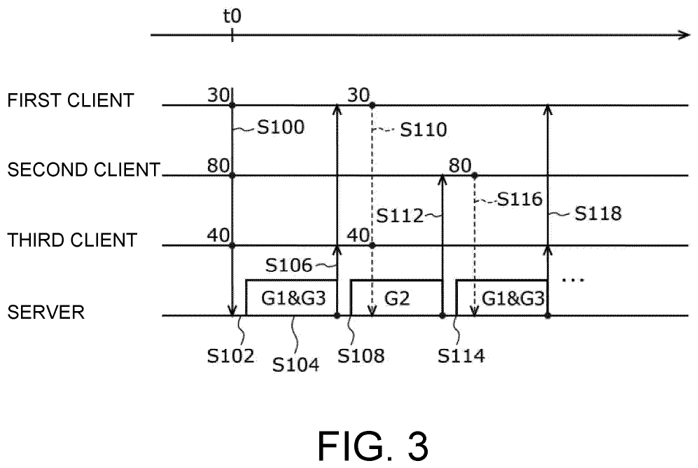

FIG. 3 is a chart illustrating a more concrete example. This is for performing processing, in parallel, about a 3rd graph G3 having a third number of nodes n3 about a third substance having a third atomicity from a third client 20C in addition to the above. For easiness, it is assumed here that n1=30, n2=80, n3=40, N=100. Further, in the chart, black points indicate transmission sources of data and tips of arrows indicate transmission destinations of data.

At a time point t0, the data about the graph is transmitted from each of the plurality of clients 20 to the server 10 (S100). Note that the time points may coincide or may deviate. Further, the time point t0 may be a time point when the server 10 confirms reception from the client 20.

On the server 10 side, it is determined whether the pieces of information on the plurality of graphs among the graphs received from the clients 20 can be collectively processed, based on the numbers of nodes of the graphs, and if there is a combination of them which can be processed at the same timing, the combination is stored (S102). For example, since n1+n2=30+80=110>100=N, it is impossible to perform arithmetic operations on the 1st graph G1 and the 2nd graph G2 at the same timing. On the other hand, since n1+n3=30+40=70<100=N, it is possible to process the 1st graph G1 and the 3rd graph G3 at the same timing. Therefore, the server 10 stores the combination of the 1st graph G1 and the 3rd graph G3 in a storage part such as a memory. Since n2+n3>N, it is determined that it is impossible to perform arithmetic operations on the 2nd graph G2 and the 3rd graph G3 at the same timing, and it is determined that the 2nd graph G2 is to be processed as a single graph.

In the case capable of collective processing, the graphs which can be collectively processed are collectively input into the trained model, whereas in the case incapable of collective processing, the graph information acquired from one client 20 is input into the trained model (S104). In the above case, the 1st graph G1 and the 3rd graph G3 can be processed at the same timing, and therefore the two graphs are collectively processed.

Upon completion of the arithmetic operations on the 1st graph G1 and the 3rd graph G3, the server 10 appropriately transmits processing results (pieces of physical property information and so on) corresponding to them to the clients 20 (S106). For example, the server 10 transmits a processing result (physical property information and so on) of the 1st graph G1 to the first client 20A, and transmits a processing result (physical property information and so on) of the 3rd graph G3 to the third client 20C.

Upon completion of the processing of the 1st graph G1 and the 3rd graph G3, the server 10 starts the processing of the 2nd graph G2 (S108).

The client 20 received the processing result from the server 10 may transmit the information about the next graph to the server 10 (S110). The server 10 may input the received information into a queue to bring it into a wait state.

Upon completion of the processing of the 2nd graph G2, the server 10 similarly transmits the processing result about the 2nd graph G2 to the second client 20B (S112).

Thereafter, such processing that the server 10 starts the processing of the 1st graph G1 and the 3rd graph G3 (S114), the second client 20B transmits the information on the next 2nd graph G2 (S116), and the server 10 transmits the processing result (S118), is repeated as many times as needed.

The client 20 transmits the pieces of information on the graphs having the same number of nodes, but not limited to this. For example, the first client 20A may make the number of nodes of the 1st graph G1 transmitted for the first time and the number of nodes of a 1'st graph G1′ transmitted for the second time different. In this case, the combination of the graphs to be processed at the same timing at appropriate timing can be changed. Further, the same client may transmit pieces of information about a plurality of graphs.

Further, in the above, the arithmetic operation is started from the combination of the 1st graph G1 and the 3rd graph G3, but not limited to this. For example, the server 10 may start from the arithmetic operation of the 2nd graph G2. As for this timing, for example, priority may be given to the combination including the graph information received first at the timing when the server 10 determines the combination. As another example, the arithmetic operation may be started from a combination including a graph having highest priority, a combination of a largest sum of priorities, or the like based on the priorities set by the server 10 or the client 20.

As explained above, according to this embodiment, it is possible to execute the processing of the graph while suppressing the waste of the resources of the server 10 based on the graph information transmitted from the client 20. The processing of the graph may be, for example, processing including an arithmetic operation of a graph neural network model. Besides, the neural network model may be the one about the NNP. The processing result for each of the pieces of information on the plurality of graphs may be information after additional processing is performed by the server 10 on the information computed using the neural network model. Besides, the processing result may be information acquired using the graph neural network model a plurality of times. Besides, the processing of the graph may be processing about an atomic simulation other than the NNP.

In this embodiment, a plurality of graphs which can be processed at the same time using the graph neural network model are selected from the plurality of pieces of graph information received from the clients. Here, “processing at the same time” may include at least one of executing part of all of the processing about the plurality of graphs at the same timing using one graph neural network model (collectively executing the part or all of the processing) and inputting one piece of input information generated from a plurality of graphs (for example, one graph made by combining the plurality of graphs) into one graph neural network model. In this event, in this embodiment, the plurality of graphs may be selected based on the resources of the server (as one example, arithmetic capacity, storage capacity, or the like).

The arithmetic operation using the NNP model deals with pieces of information on a large number of atoms and is thus large in arithmetic amount. Accordingly, by selecting a graph to be processed based on the arithmetic resources as in this embodiment, the resources of the server can be effectively used.

Besides, when receiving the information on the graph having a number of nodes of 40 and the information on the graph having a number of nodes 60 from a plurality of clients, the server executes the processing of the two graphs in parallel as explained above. On the other hand, when receiving the information on the graph having a number of nodes of 40 and the information on the graph having a number of nodes of 70, the server may execute sequential processing, without selecting the graph, in a manner to first process the graph having a number of nodes of 40 and then process the graph having a number of nodes of 70 because the predetermined number of nodes is exceeded.

### Second Embodiment

The change of the order of graphs in the server 10 which executes the arithmetic operations is explained in the above embodiment, and an intermediate server may be provided between the plurality of clients 20 and the server 10, which executes queue or task processing of making the server 10 perform arithmetic operations based on the graphs transmitted from the clients 20, and selects the order of the graph processing and the combination of the plurality of graphs in the server 10.

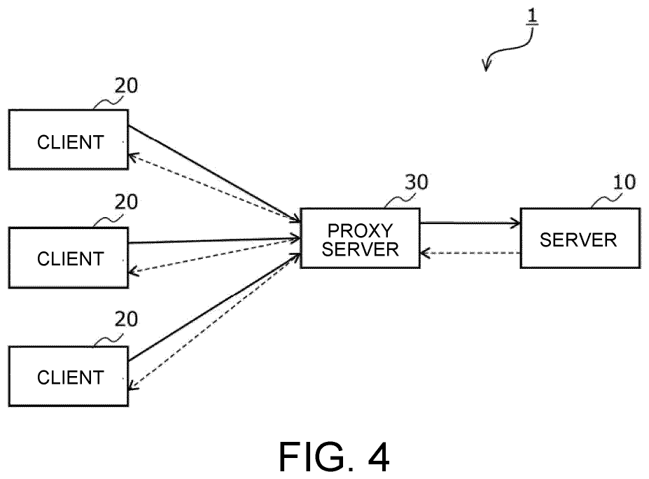

FIG. 4 is a diagram illustrating the outline of an information processing system 1 according to an embodiment. The information processing system 1 includes a proxy server 30 (an example of a third information processing device) as a first intermediate server.

The proxy server 30 is connected between the client 20 and the server 10. Specifically, the server 10 acquires, from a plurality of clients 20 via the proxy server 30, the order of processing the graphs, the information about the combination, and the information on the graphs to be subjected to arithmetic processing.

The server 10 may include a queue on which FIFO (First-In First-Out) processing is executed. The server 10 performs enqueuing and dequeuing at appropriate timing. Further, as another example, the server 10 may perform enqueuing and dequeuing on a request from the proxy server 30.

The clients 20 transmit, to the proxy server 30, requests for arithmetic operations of graphs on which they desire the server 10 to execute arithmetic operations and pieces of information on the graphs. The proxy server 30 determines and detects a combination of the graphs to be processed in the same accelerator at the same timing based on the pieces of information on the graphs received from the clients 20, and transmits the combination to the server 10. At this timing, it may also transmit the pieces of information on the graphs. The server 10 performs enqueuing based on the requests. Then, the server 10 performs dequeuing at appropriate timing to execute arithmetic processing.

As another example, the proxy server 30 may transmit an enqueue request about tasks regarding the graphs in the appropriate order and combination to the server 10. Then, the proxy server 30 transmits a dequeue request to the server 10, whereby the server 10 may execute the arithmetic operations. For example, the dequeue request from the proxy server 30 may be a flush request to the server 10.

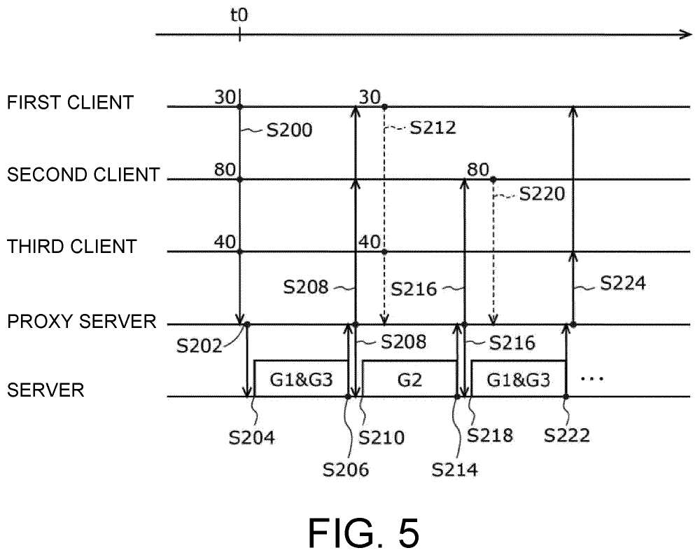

FIG. 5 is a chart illustrating an example in which the timing of the processing relating to this embodiment is not limited. The basic configuration is similar to that in the case of FIG. 3.

First, each of the clients 20 transmits the information on the graph and the arithmetic operation request to the proxy server 30 (S200).

The proxy server 30 confirms the number of nodes in each graph and transmits an arithmetic task to the server 10 based on the number of nodes, and the server 10 enqueues the received task (S202).

Further, as another example, the proxy server 30 may transmit an enqueue request to the server 10, and the server 10 may perform enqueuing based on the request (S202). Then, the proxy server 30 transmits a dequeue request to the server 10, whereby the server 10 may dequeue the task and execute the processing of the graph (S204).

The server 10 manages the graphs to be processed at the same timing explained in the above embodiment as one queue. In the example of FIG. 5, the arithmetic operation requests of the 1st graph G1 and the 3rd graph G3 are enqueued as one queue, and subsequently the arithmetic operation request of the 2nd graph G2 is enqueued as one queue. The order is decided based on any appropriate method as in the above.

The server 10 (arithmetic server) executes processing according to the enqueued queue (S206). The server 10 may perform dequeuing at appropriate timing to execute the FIFO processing, or the proxy server 30 may transmit the dequeue request and the server 10 may perform dequeuing to start the arithmetic processing.

The transmission of data about the graph from the client 20 to the server 10 or from the proxy server 30 to the server 10 just needs to be executed at appropriate timing. As another configuration example, the information itself on the graph may be transmitted from the client 20 or the proxy server 30 to a storage or the like, and the server 10 may acquire the information on the graph based on the dequeued task and start the arithmetic operation. Further, in this case, the server 10 may prefetch the data based on the enqueued information.

Upon completion of the arithmetic processing, the server 10 transmits a processing result to the proxy server 30 and notifies it of the completion of the arithmetic operation (S206). Note that such a mode may be adopted that the processing result is transmitted to a not-illustrated file server or the like or transmitted directly from the server 10 to each of the clients 20.

The proxy server 30 which has received the notification of the completion of the arithmetic operation transmits the arithmetic operation result to an appropriate client 20 and executes next processing according to the queue (S208). For example, in the above state, because there is a processing queue of the 2nd graph G2, the next dequeue request may be transmitted from the proxy server 30 to the server 10 at this timing.

The server 10 dequeues the task about the 2nd graph G2 and executes the processing (S210). As in the preceding paragraph, the server 10 may perform dequeuing in response to the request from the proxy server 30 or may perform dequeuing at appropriate timing after completion of the transmission of the processing result at S206. In the case where the proxy server 30 performs a dequeue request, the order of the transmission of the processing result and the dequeue request is arbitrary, and they may be performed one after another or at the same time.

As in the case of FIG. 3, the first client 20A and the third client 20C transmit the next processing requests to the proxy server 30 as needed (S212). Note that the processing requests may be performed not at this timing but during the execution of the preceding processing (S206) or before or after the execution. In this case, the proxy server 30 appropriately decides the combination based on the numbers of nodes of the graphs, and the server 10 sequentially performs enqueuing based on the pieces of information on the graphs received from the proxy server 30.

Upon completion of the processing of the 2nd graph G2, the server 10 notifies the proxy server 30 of the completion of the processing (S214), and the proxy server 30 transmits the arithmetic operation result to the second client 20B. At this timing, the proxy server 30 may transmit the dequeue request to the server 10. As a matter of course, the server 10 may perform appropriate dequeuing and execute processing without transmission of the request from the proxy server 30.

Thereafter, the processing by the server 10 (S218), the processing request from the second client 20B (S220), the transmission and the like of the processing result from the server 10 (S222), and the transmission and the like of various data from the proxy server 30 to the client 20 or the server 10 (S224), are appropriately repeated.

As explained above, the case in which the clients 20 sequentially perform processing is explained in FIG. 5, but not limited to this. For example, at a time point t0, the plurality of clients 20 may transmit the arithmetic operation requests about the pieces of information on the plurality of graphs to the proxy server 30. The proxy server 30 appropriately decides the combination of the graphs and the order of the processing, and the server 10 performs enqueuing based on the order of the processing. This also applies to the above embodiment, and the plurality of clients 20 may transmit the pieces of information on the plurality of graphs to the server 10 at the time point t0.

The proxy server 30 may decide the order of the arithmetic processing of the graphs, for example, in a manner that request of the processing from the same client 20 is not successive as much as possible, or may decide the order of the arithmetic processing of the graphs in a manner that the request of the processing from the client 20 with higher priority is ended as early as possible and the waste of the resources in the server 10 is suppressed.

As explained above, according to this embodiment, the use of the queue via the proxy server 30 enables the server 10 to execute the arithmetic processing in the appropriate order and the appropriate combination of the graphs.

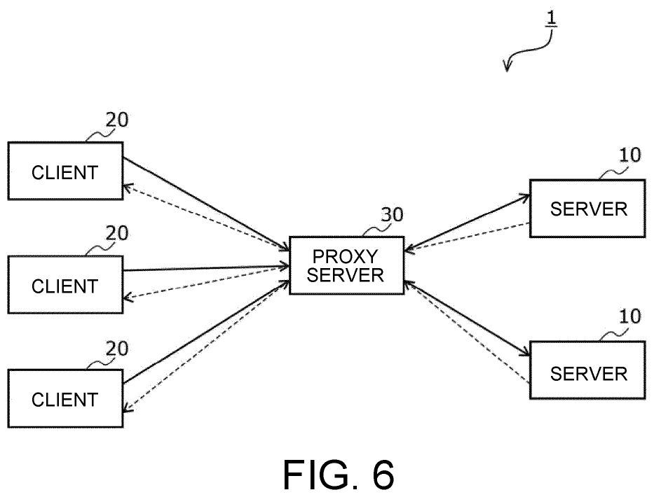

FIG. 6 is a diagram illustrating another example of this embodiment. As illustrated in FIG. 6, the information processing system 1 may include a plurality of servers 10. In this case, the proxy server 30 may allot the processing in the order of the tasks dequeued in the servers 10. As another example, the proxy server 30 may appropriately couple and divide the pieces of information on the graphs received from the plurality of clients 20 based on the performance or the like of each of the servers 10 and allot the task to each of the servers 10, and each of the servers 10 may enqueue the allotted task.

For example, to the server having an accelerator with high performance, a request having a large atomicity (number of nodes) to be computed may be allocated. On the other hand, to a server having an accelerator with performance lower than that of the above server, a request having a smaller atomicity (number of nodes) to be computed may be allocated. This allocation enables effective use of the resources of the accelerators. The high performance here may be decided, for example, according to a large number of arithmetic cores, a large number of arithmetic clocks, or the like.

Besides, the allocation by the similar mechanism makes it possible to enhance the possibility for aggregating the requests each having a smaller atomicity to the same server as much as possible and performing computation in batch.

The allotment according to the performance also applies to the following embodiment.

### Third Embodiment

In addition to the implementation of the above second embodiment, the servers 10 having equivalent performances may be grouped together as a server group, and a load balancer may be provided to allot which of the servers 10 belonging to the server group is made to execute the arithmetic operation.

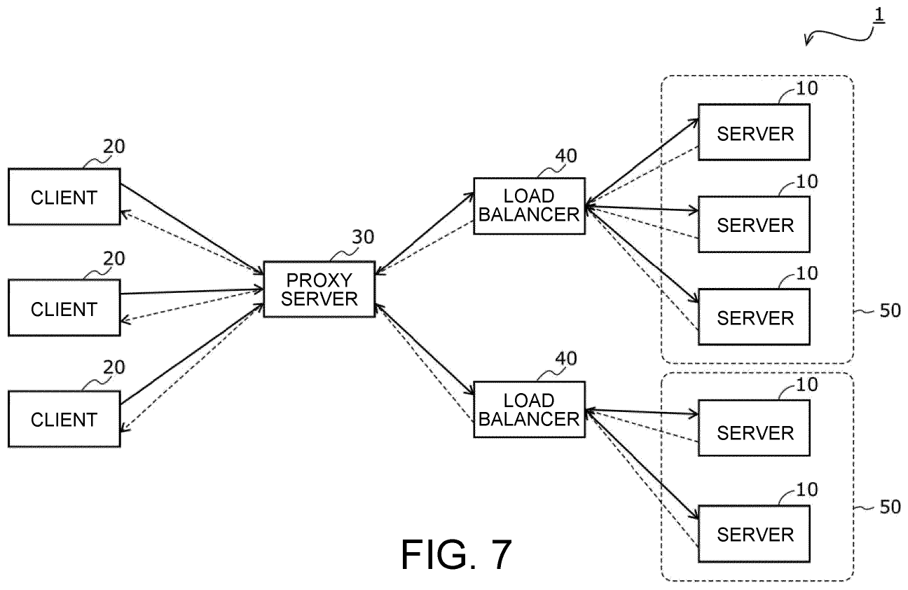

FIG. 7 is a diagram illustrating the outline of an information processing system 1 according to an embodiment. The information processing system 1 includes a plurality of servers 10, and a load balancer 40 (an example of a fourth information processing device) as a second intermediate server between a proxy server 30 and the plurality of servers 10.

The plurality of servers 10 are separated into a plurality of server groups 50 according to the performances. The server groups 50 are classified, for example, according to the numbers of nodes of the graphs which can be processed at the same timing in the servers 10. Besides, the server groups 50 may be classified according to the processing speeds of the servers 10.

The allotment of the plurality of servers 10 to the server groups 50 is not limited to the above. For example, even if there are servers 10 having equivalent performance, the servers 10 can be grouped also based on the condition under which the proxy server 30 desires to allot the processing. Specifically, the servers 10 having equivalent performance may be allotted such that they are allotted to the server group 50 in charge of the processing of a request having a small number of nodes and the server group 50 in charge of the processing of a request having a large number of nodes so as to increase as much as possible the number of graphs which can be executed at a time.

The load balancer 40 may be provided for each of the server groups 50. The proxy server 30 allots the processing requests of the graphs received from the clients 20 based on the performances of the servers 10 constituting the server group 50. In the above example, the proxy server 30 may allot them to each of the server groups 50 based on the numbers of nodes which can be processed at the same timing in the servers 10 or may allot them based on the processing speeds of the servers 10.

The proxy server 30 may allot the task to each of the load balancers 40. In this case, the proxy server 30 selects the information about an appropriate graph for each of the load balancers 40 and transmits the processing request (task). The load balancer 40 allots the task to the servers 10 belonging to the server group 50 of which the load balancer 40 is in charge, to thereby cause the server 10 to execute the arithmetic processing.

The load balancer 40 assigns a server 10 appropriate for the processing from the server group 50 based on the information on the graph received from the proxy server 30, and transmits the information about the graph to the assigned server 10. Upon reception of the information on the graph, the server 10 appropriately acquires the data on the graph and executes processing. The server 10 may include a queue as in the above, and may enqueue the tasks regarding the processing of the graph allotted by the load balancer 40. Then, the server 10 may execute the processing of the tasks in order for the graph according to this queue. After the processing, the load balancer 40 may be notified of the completion of the processing. If there is a next arithmetic task, the server 10 shifts to execution of the next arithmetic operation.

The information processing system 1 according to this embodiment first appropriately allots the pieces of information on the graphs received from the clients 20 in the proxy server 30 being the first intermediate server as explained in the above. The proxy server 30 may allot them to each of the load balancers 40 based on the pieces of allotted information.

Then, the load balancer 40 assigns a processing instruction to each of the servers 10 so as to disperse the loads on the plurality of servers 10, and notifies an appropriate server 10 of the processing instruction. The server 10 appropriately executes processing about the graph based on the processing request, and notifies, after completion of the processing, the load balancer 40 of the fact the processing has been completed. As needed, the server 10 performs enqueuing into the queue based on the processing request, and if there is a task in the queue after the completion of the processing, performs dequeuing and executes the next processing. The load balancer 40 may monitor each of the servers 10 and detect that the processing is completed, and may allot the graph processing task to each of the servers according to the processing states of the servers 10.

For example, if there is no standing-by server 10, the load balancer 40 may assign the task about the next graph processing to the server 10 which has been notified of the processing request first. The server 10 may enqueue the task as needed and perform dequeuing after completion of the current task, thereby sequentially executing the processing. Further, in this case, the load balancer 40 may hold a buffer and include a queue in the buffer, and may perform dequeuing to assign the task to the server 10 which has completed the processing. Besides, if there is a performance difference in the server group 50, the load balancer 40 may assign the task to an appropriate server 10.

Into/from the queue, only the instruction and the request may be enqueued and dequeued, and those including the information on the graph may be enqueued and dequeued. In the case where only the arithmetic operation request is input into the queue, the information about the graph dequeued by the server 10 and/or the information about the graph required for the arithmetic operation from a not-illustrated storage part may be acquired and the processing may be executed as in the above embodiment.

As explained above, according to this embodiment, the provision of the load balancer 40 enables dispersion of the loads and enables the server 10 to execute the processing more appropriately in terms of load and time.

As in the first embodiment, the server 10 may execute the arithmetic operation using the neural network model using the graph as an input also in the second embodiment and the third embodiment. In particular, it is desirably configured as a neural network model, when a plurality of independent graphs are input, which does not influence another independent graph.

This neural network model may be the one to be used for the NNP, and the information on the graph may be the information on the substance, and the node may correspond to the atomic structure of the substance. The number of nodes corresponds to the atomicity, and the server 10 which executes the arithmetic operation is assigned according to the atomicity. In this case, the server 10 deploys the neural network model to be used for the NNP in advance, and sequentially inputs the information about the input graph into an input layer of the neural network model, and thereby can continuously execute the processing. By fixing the trained model to be used, it becomes possible to avoid the waste of time required for forming the model.

By using the intermediate server as in the second embodiment and the third embodiment, it is possible, in the case of providing the NNP, to reduce the load and the cost as a whole as a provider and to reduce the economical cost and time cost as a user. For example, in the case of using a server in a time charge system or an arithmetic amount charge system, the graphs which can be integrated can be collectively subjected to an arithmetic operation, thus making it possible to suppress the cost in terms of both financial and time aspects.

In each of the above embodiments, the data on the graph is transmitted/received. This is a non-limited example, and other necessary data may be additionally transmitted as metadata. Representatively, the atomicity (the number of nodes of the graph used for an arithmetic operation) constituting the substance may be given as the metadata, and various servers may read the number of nodes in the metadata to execute processing. Further, the metadata may include information about the type of atom. The metadata may be used for allotment conditions of the aforementioned graphs to be processed in the same accelerator at the same timing and used for allotment conditions of the servers for executing the processing for the graphs in the case where there are a plurality of servers.

Note that the configuration including the server 10, the proxy server 30, and the load balancer 40 has been explained in each of the above embodiments, and a server (an example of the information processing device) made by collecting part or all of the functions may be constituted. More specifically, the proxy server 30 and the arithmetic server (server 10) may be provided in the server, and the load balancer 40 may be provided in addition to them. Besides, the load balancer 40 and the arithmetic server (server 10) may be provided in the server. Besides, the functions of the proxy server 30 and the load balancer 40 may be realized by one information processing device. Besides, these servers may be connected via the internet line or the like and integrated as one server. These configurations are not particularly limited but just need to be modes which can implement the similar functions.

Note that the processing is allocated to the server from the proxy server via the load balancer in the above, but not limited to this mode. For example, in the case where the number of processes increases, the configuration may include a plurality of proxy servers, and one or more load balancers may be provided between the proxy servers and the clients. The provision of the load balancers enables dispersion of the loads on the proxy servers. In this case, in order to keep the same state in the plurality of proxy servers, the data may be managed by KVS (Key-Value Store).

All of the above trained models may be, for example, concepts which are trained as explained above and further include models distilled by a general method.

The trained models of above embodiments may be, for example, a concept that includes a model that has been trained as described and then distilled by a general method.

Some or all of each device (each device of the information processing system 1) in the above embodiment may be configured in hardware, or information processing of software (program) executed by, for example, a CPU (Central Processing Unit), GPU (Graphics Processing Unit). In the case of the information processing of software, software that enables at least some of the functions of each device in the above embodiments may be stored in a non-volatile storage medium (non-volatile computer readable medium) such as CD-ROM (Compact Disc Read Only Memory) or USB (Universal Serial Bus) memory, and the information processing of software may be executed by loading the software into a computer. In addition, the software may also be downloaded through a communication network. Further, entire or a part of the software may be implemented in a circuit such as an ASIC (Application Specific Integrated Circuit) or FPGA (Field Programmable Gate Array), wherein the information processing of the software may be executed by hardware.

A storage medium to store the software may be a removable storage media such as an optical disk, or a fixed type storage medium such as a hard disk, or a memory. The storage medium may be provided inside the computer (a main storage device or an auxiliary storage device) or outside the computer.

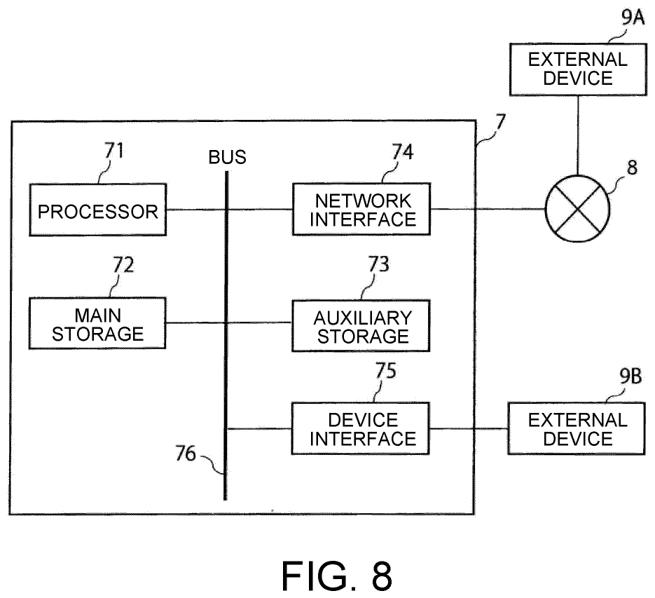

FIG. 8 is a block diagram illustrating an example of a hardware configuration of each device (each device of the information processing system 1) in the above embodiments. As an example, each device may be implemented as a computer 7 provided with a processor 71, a main storage device 72, an auxiliary storage device 73, a network interface 74, and a device interface 75, which are connected via a bus 76.

The computer 7 of FIG. 8 is provided with each component one by one but may be provided with a plurality of the same components. Although one computer 7 is illustrated in FIG. 8, the software may be installed on a plurality of computers, and each of the plurality of computer may execute the same or a different part of the software processing. In this case, it may be in a form of distributed computing where each of the computers communicates with each of the computers through, for example, the network interface 74 to execute the processing. That is, each device (each device of the information processing system 1) in the above embodiments may be configured as a system where one or more computers execute the instructions stored in one or more storages to enable functions. Each device may be configured such that the information transmitted from a terminal is processed by one or more computers provided on a cloud and results of the processing are transmitted to the terminal.

Various arithmetic operations of each device (each device of the information processing system 1) in the above embodiments may be executed in parallel processing using one or more processors or using a plurality of computers over a network. The various arithmetic operations may be allocated to a plurality of arithmetic cores in the processor and executed in parallel processing. Some or all the processes, means, or the like of the present disclosure may be implemented by at least one of the processors or the storage devices provided on a cloud that can communicate with the computer 7 via a network. Thus, each device in the above embodiments may be in a form of parallel computing by one or more computers.

The processor 71 may be an electronic circuit (such as, for example, a processor, processing circuity, processing circuitry, CPU, GPU, FPGA, or ASIC) that executes at least controlling the computer or arithmetic calculations. The processor 71 may also be, for example, a general-purpose processing circuit, a dedicated processing circuit designed to perform specific operations, or a semiconductor device which includes both the general-purpose processing circuit and the dedicated processing circuit. Further, the processor 71 may also include, for example, an optical circuit or an arithmetic function based on quantum computing.

The processor 71 may execute an arithmetic processing based on data and/or a software input from, for example, each device of the internal configuration of the computer 7, and may output an arithmetic result and a control signal, for example, to each device. The processor 71 may control each component of the computer 7 by executing, for example, an OS (Operating System), or an application of the computer 7.

Each device (each device of the information processing system 1) in the above embodiments may be enabled by one or more processors 71. The processor 71 may refer to one or more electronic circuits located on one chip, or one or more electronic circuitries arranged on two or more chips or devices. In the case of a plurality of electronic circuitries are used, each electronic circuit may communicate by wired or wireless.

The main storage device 72 may store, for example, instructions to be executed by the processor 71 or various data, and the information stored in the main storage device 72 may be read out by the processor 71. The auxiliary storage device 73 is a storage device other than the main storage device 72. These storage devices shall mean any electronic component capable of storing electronic information and may be a semiconductor memory. The semiconductor memory may be either a volatile or non-volatile memory. The storage device for storing various data or the like in each device (each device of the information processing system 1) in the above embodiments may be enabled by the main storage device 72 or the auxiliary storage device 73 or may be implemented by a built-in memory built into the processor 71. For example, the storages in the above embodiments may be implemented in the main storage device 72 or the auxiliary storage device 73.

In the case of each device (each device of the information processing system 1) in the above embodiments is configured by at least one storage device (memory) and at least one of a plurality of processors connected/coupled to/with this at least one storage device, at least one of the plurality of processors may be connected to a single storage device. Or at least one of the plurality of storages may be connected to a single processor. Or each device may include a configuration where at least one of the plurality of processors is connected to at least one of the plurality of storage devices. Further, this configuration may be implemented by a storage device and a processor included in a plurality of computers. Moreover, each device may include a configuration where a storage device is integrated with a processor (for example, a cache memory including an L1 cache or an L2 cache).

The network interface 74 is an interface for connecting to a communication network 8 by wireless or wired. The network interface 74 may be an appropriate interface such as an interface compatible with existing communication standards. With the network interface 74, information may be exchanged with an external device 9A connected via the communication network 8. Note that the communication network 8 may be, for example, configured as WAN (Wide Area Network), LAN (Local Area Network), or PAN (Personal Area Network), or a combination of thereof, and may be such that information can be exchanged between the computer 7 and the external device 9A. The internet is an example of WAN, IEEE802.11 or Ethernet (registered trademark) is an example of LAN, and Bluetooth (registered trademark) or NFC (Near Field Communication) is an example of PAN.

The device interface 75 is an interface such as, for example, a USB that directly connects to the external device 9B. The external device 9A is a device connected to the computer 7 via a network. The external device 9B is a device directly connected to the computer 7.

The external device 9A or the external device 9B may be, as an example, an input device. The input device is, for example, a device such as a camera, a microphone, a motion capture, at least one of various sensors, a keyboard, a mouse, or a touch panel, and gives the acquired information to the computer 7. Further, it may be a device including an input unit such as a personal computer, a tablet terminal, or a smartphone, which may have an input unit, a memory, and a processor.

The external device 9A or the external device 9B may be, as an example, an output device. The output device may be, for example, a display device such as, for example, an LCD (Liquid Crystal Display), or an organic EL (Electro Luminescence) panel, or a speaker which outputs audio. Moreover, it may be a device including an output unit such as, for example, a personal computer, a tablet terminal, or a smartphone, which may have an output unit, a memory, and a processor.

Further, the external device 9A or the external device 9B may be a storage device (memory). The external device 9A may be, for example, a network storage device, and the external device 9B may be, for example, an HDD storage.

Furthermore, the external device 9A or the external device 9B may be a device that has at least one function of the configuration element of each device (each device of the information processing system 1) in the above embodiments. That is, the computer 7 may transmit a part of or all of processing results to the external device 9A or the external device 9B, or receive a part of or all of processing results from the external device 9A or the external device 9B.

In the present specification (including the claims), the representation (including similar expressions) of “at least one of a, b, and c” or “at least one of a, b, or c” includes any combinations of a, b, c, a-b, a-c, b-c, and a-b-c. It also covers combinations with multiple instances of any element such as, for example, a-a, a-b-b, or a-a-b-b-c-c. It further covers, for example, adding another element d beyond a, b, and/or c, such that a-b-c-d.

In the present specification (including the claims), the expressions such as, for example, “data as input,” “using data,” “based on data,” “according to data,” or “in accordance with data” (including similar expressions) are used, unless otherwise specified, this includes cases where data itself is used, or the cases where data is processed in some ways (for example, noise added data, normalized data, feature quantities extracted from the data, or intermediate representation of the data) are used. When it is stated that some results can be obtained “by inputting data,” “by using data,”“based on data,”“according to data,”“in accordance with data” (including similar expressions), unless otherwise specified, this may include cases where the result is obtained based only on the data, and may also include cases where the result is obtained by being affected factors, conditions, and/or states, or the like by other data than the data. When it is stated that “output/outputting data” (including similar expressions), unless otherwise specified, this also includes cases where the data itself is used as output, or the cases where the data is processed in some ways (for example, the data added noise, the data normalized, feature quantity extracted from the data, or intermediate representation of the data) is used as the output.

In the present specification (including the claims), when the terms such as “connected (connection)” and “coupled (coupling)” are used, they are intended as non-limiting terms that include any of “direct connection/coupling,” “indirect connection/coupling,” “electrically connection/coupling,” “communicatively connection/coupling,” “operatively connection/coupling,” “physically connection/coupling,” or the like. The terms should be interpreted accordingly, depending on the context in which they are used, but any forms of connection/coupling that are not intentionally or naturally excluded should be construed as included in the terms and interpreted in a non-exclusive manner.

In the present specification (including the claims), when the expression such as “A configured to B,” this may include that a physically structure of A has a configuration that can execute operation B, as well as a permanent or a temporary setting/configuration of element A is configured/set to actually execute operation B. For example, when the element A is a general-purpose processor, the processor may have a hardware configuration capable of executing the operation B and may be configured to actually execute the operation B by setting the permanent or the temporary program (instructions). Moreover, when the element A is a dedicated processor, a dedicated arithmetic circuit, or the like, a circuit structure of the processor or the like may be implemented to actually execute the operation B, irrespective of whether or not control instructions and data are actually attached thereto.

In the present specification (including the claims), when a term referring to inclusion or possession (for example, “comprising/including,” “having,” or the like) is used, it is intended as an open-ended term, including the case of inclusion or possession an object other than the object indicated by the object of the term. If the object of these terms implying inclusion or possession is an expression that does not specify a quantity or suggests a singular number (an expression with a or an article), the expression should be construed as not being limited to a specific number.

In the present specification (including the claims), although when the expression such as “one or more,” “at least one,” or the like is used in some places, and the expression that does not specify a quantity or suggests a singular number (the expression with a or an article) is used elsewhere, it is not intended that this expression means “one.” In general, the expression that does not specify a quantity or suggests a singular number (the expression with a or an as article) should be interpreted as not necessarily limited to a specific number.

In the present specification, when it is stated that a particular configuration of an example results in a particular effect (advantage/result), unless there are some other reasons, it should be understood that the effect is also obtained for one or more other embodiments having the configuration. However, it should be understood that the presence or absence of such an effect generally depends on various factors, conditions, and/or states, etc., and that such an effect is not always achieved by the configuration. The effect is merely achieved by the configuration in the embodiments when various factors, conditions, and/or states, etc., are met, but the effect is not always obtained in the claimed invention that defines the configuration or a similar configuration.

In the present specification (including the claims), when the term such as “maximize/maximization” is used, this includes finding a global maximum value, finding an approximate value of the global maximum value, finding a local maximum value, and finding an approximate value of the local maximum value, should be interpreted as appropriate accordingly depending on the context in which the term is used. It also includes finding on the approximated value of these maximum values probabilistically or heuristically. Similarly, when the term such as “minimize” is used, this includes finding a global minimum value, finding an approximated value of the global minimum value, finding a local minimum value, and finding an approximated value of the local minimum value, and should be interpreted as appropriate accordingly depending on the context in which the term is used. It also includes finding the approximated value of these minimum values probabilistically or heuristically. Similarly, when the term such as “optimize” is used, this includes finding a global optimum value, finding an approximated value of the global optimum value, finding a local optimum value, and finding an approximated value of the local optimum value, and should be interpreted as appropriate accordingly depending on the context in which the term is used. It also includes finding the approximated value of these optimal values probabilistically or heuristically.

In the present specification (including claims), when a plurality of hardware performs a predetermined process, the respective hardware may cooperate to perform the predetermined process, or some hardware may perform all the predetermined process. Further, a part of the hardware may perform a part of the predetermined process, and the other hardware may perform the rest of the predetermined process. In the present specification (including claims), when an expression (including similar expressions) such as “one or more hardware perform a first process and the one or more hardware perform a second process,” or the like, is used, the hardware that perform the first process and the hardware that perform the second process may be the same hardware, or may be the different hardware. That is: the hardware that perform the first process and the hardware that perform the second process may be included in the one or more hardware. Note that, the hardware may include an electronic circuit, a device including the electronic circuit, or the like.

In the present specification (including the claims), when a plurality of storage devices (memories) store data, an individual storage device among the plurality of storage devices may store only a part of the data or may store the entire data. Further, some storage devices among the plurality of storage devices may include a configuration for storing data.

While certain embodiments of the present disclosure have been described in detail above, the present disclosure is not limited to the individual embodiments described above. Various additions, changes, substitutions, partial deletions, etc. are possible to the extent that they do not deviate from the conceptual idea and purpose of the present disclosure derived from the contents specified in the claims and their equivalents. For example, when numerical values or mathematical formulas are used in the description in the above-described embodiments, they are shown for illustrative purposes only and do not limit the scope of the present disclosure. Further, the order of each operation shown in the embodiments is also an example, and does not limit the scope of the present disclosure.

1. An information processing device comprising:
one or more memories; and
one or more processors configured to:
receive information on a plurality of graphs from one or more second information processing devices;
select a plurality of graphs which are simultaneously processable using a graph neural network model among the plurality of graphs;
input information on the plurality of graphs which are simultaneously processable into the graph neural network model and simultaneously process the information on the plurality of graphs which are simultaneously processable to acquire a processing result for each of the plurality of graphs which are simultaneously processable; and
transmit the processing result to the second information processing device which has transmitted the corresponding information on the graph.

2. The information processing device according to claim 1, wherein the one or more processors select the plurality of graphs which are simultaneously processable among the plurality of graphs based on resources of the information processing device.

3. The information processing device according to claim 1, wherein the one or more processors select the plurality of graphs which are simultaneously processable based on at least one of the number of nodes or the number of edges of each graph included in the plurality of graphs.

4. The information processing device according to claim 1, wherein the one or more processors select the plurality of graphs which are simultaneously processable based on a priority, wherein the priority includes at least one of a priority set for the one or more second information processing devices, a priority set for the information processing device, or a priority set by the one or more second information processing devices.

5. The information processing device according to claim 3, wherein the one or more processors are configured to:
receive information on a first graph having a first number of nodes and information on a second graph having a second number of nodes, and
select the first graph and the second graph as the plurality of graphs which are simultaneously processable when at least a sum of the first number of nodes and the second number of nodes is a predetermined number of nodes or less.

6. The information processing device according to claim 5, wherein the one or more processors are configured to:
further receive information on a third graph having a third number of nodes,
select the first graph and the second graph as the plurality of graphs which are simultaneously processable when at least a sum of the first number of nodes, the second number of nodes, and the third number of nodes exceeds the predetermined number of nodes and the sum of the first number of nodes and the second number of nodes is the predetermined number of nodes or less, and
inputs the information on the third graph into the graph neural network model at timing different from timing of the plurality of graphs which are simultaneously processable.

7. The information processing device according to claim 1, wherein the graph neural network model is an NNP (Neural Network Potential) model.

8. The information processing device according to claim 7, wherein the number of nodes comprised in each of the plurality of the graphs is a value based on a number of atoms.

9. The information processing device according to claim 7, wherein the processing result comprises at least one of information on energy or information on force.

10. The information processing device according to claim 1, wherein the one or more processors are configured to:
receive the information on the plurality of graphs from the one or more second information processing devices via one or more other information processing devices; and
transmit the processing result to the second device which has transmitted the corresponding information of the graph via the one or more other information processing devices.

11. The information processing device according to claim 10, wherein the graph neural network model is an NNP model.

12. The information processing device according to claim 1, wherein the information processing device comprises a plurality of devices.

13. An information processing device comprising:
one or more memories; and
one or more processors configured to:
receive information on a plurality of graphs from a third information processing device;
select a first information processing device which executes arithmetic operations on the plurality of graphs using a graph neural network model from among a plurality of first information processing devices;
transmit the information on the plurality of graphs to the selected first information processing device;
receive a processing result for each of the plurality of graphs, from the selected first information processing device; and
transmit the processing result to the third information processing device; and
the information on the plurality of graphs is information on a plurality of graphs which are simultaneously processable using the graph neural network model among information on a plurality of graphs transmitted from one or more second information processing devices.

14. The information processing device according to claim 13, wherein the graph neural network model is an NNP model.

15. An information processing method comprising:
receiving, by one or more information processing devices, information on a plurality of graphs from one or more second information processing devices;
selecting, by the one or more information processing devices, a plurality of graphs which are simultaneously processable using a graph neural network model among the plurality of graphs;
inputting, by the one or more information processing devices, information on the plurality of graphs which are simultaneously processable into the graph neural network model and simultaneously processing the information on the plurality of graphs which are simultaneously processable to acquire a processing result for each of the plurality of graphs which are simultaneously processable; and
transmitting, by the one or more information processing devices, the processing result to the second information processing device which has transmitted the corresponding information on the graph.

16. The information processing method according to claim 15 further comprising selecting, by the one or more information processing devices, the plurality of graphs which are simultaneously processable among the plurality of graphs based on resources of the one or more information processing devices.

17. The information processing method according to claim 15 further comprising selecting, by the one or more information processing devices, the plurality of graphs which are simultaneously processable based on at least one of the number of nodes or the number of edges of each graph included in the plurality of graphs.

18. The information processing method according to claim 15 further comprising selecting, by the one or more information processing devices, the plurality of graphs which are simultaneously processable based on a priority, wherein the priority includes at least one of a priority set for the one or more second information processing devices, a priority set for the one or more information processing devices, or a priority set by the one or more second information processing devices.

19. The information processing method according to claim 17 further comprising receiving, by the one or more information processing devices, information on a first graph having a first number of nodes and information on a second graph having a second number of nodes, and selecting, by the one or more information processing devices, the first graph and the second graph as the plurality of graphs which are simultaneously processable when at least a sum of the first number of nodes and the second number of nodes is a predetermined number of nodes or less.

20. An information processing method comprising:
receiving, by one or more processors, information on a plurality of graphs from a third information processing device;
selecting, by the one or more processors, a first information processing device which executes arithmetic operations on the plurality of graphs using a graph neural network model from among a plurality of first information processing devices;
transmitting, by the one or more processors, the information on the plurality of graphs to the selected first information processing device;
receiving, by the one or more processors, a processing result for each of the plurality of graphs, from the selected first information processing device; and
transmitting, by the one or more processors, the processing result to the third information processing device, wherein
the information on the plurality of graphs is information on a plurality of graphs which are simultaneously processable using the graph neural network model among information on a plurality of graphs transmitted from one or more second information processing devices.
